(19) United States
(12) Patent Application Publication
(10) Pub. No.: US 2010/0326530 A1
(43) Pub. Date: Dec. 30, 2010

(54) PIEZOELECTRIC FLOW CONTROL VALVE

(75) Inventor: Paul B. DuPuis, Glendale, AZ (US)

Correspondence Address: HONEYWELL/FOGG;Patent Services, 101 Columbia Road, P.O Box 2245, Morristown, NJ, 07962-2245, US

(73) Assignee: Honeywell International, Inc., Morristown, NJ (US)

(21) Appl. No.: 11/934,000

(22) Filed: Nov. 1, 2007

(51) Int. Cl. F15D 1/00; F16K 31/02

(52) U.S. Cl. 137/1; 251/129.01

(57) ABSTRACT

A flow control valve includes an electrically controlled piezoelectric actuator, at least one pressure fitting and nozzle, and a nozzle orifice sealing mechanism coupled to the piezoelectric actuator. The piezoelectric actuator may be a piezo-ceramic actuator fixed along one side to a chamber of the flow control valve and having a free side opposite the fixed side. Upon receiving a voltage of a desired magnitude and polarity, the free side of the piezo-ceramic actuator and the nozzle orifice sealing mechanism moves to control a fluid flow into the chamber. By controllably dithering the piezoelectric actuator of the flow control valve, an output flow from the chamber may be accurately regulated.

### BACKGROUND OF THE INVENTION

Flow control valves are used to control fluid flow rates in a variety of applications. One particular application relates to controlling a fluid flow in a pneumatic test apparatus when testing various pneumatic pressure systems or components that are to be installed on an aircraft. By way of example, one type of pneumatic test apparatus is an air data tester (ADT), which is often employed in ground testing aircraft aerospace systems or components. One type of aerospace test system simulates in-flight air pressures to supply pneumatic data to an aircraft control and display avionics system, which in turn provides data regarding the aircraft's altitude, vertical speed, airspeed, Mach number, etc.

The flow control valve must be capable of precisely duplicating in-flight pneumatic pressures normally encountered by an aircraft over its entire flight profile. Existing valves, such as those described in U.S. Pat. Nos. 4,131,130 and 6,202,669 are generally complex assemblies that are sensitive to a number of individual part tolerances between nozzle orifices. The valves described in the identified patents include an electromagnetic torque motor for moving a flapper mechanism relative to a nozzle orifice of a pressure fitting. Due to the complexity of the assemblies and the interrelated mechanical tolerance sensitivity, the aforementioned valves are difficult to manufacture in large quantities in a short period of time. In addition, the complex assembly increases cost.

### SUMMARY OF THE INVENTION

The present invention general relates to a flow control valve that utilizes an electrically controlled piezoelectric actuator in lieu of the above-described electromagnetic pressure control system. The piezoelectric actuator and other components of the valve are much less sensitive to, if not immune from, the above-described interrelated mechanical tolerances between the nozzle orifices, the complex geometry and the precise manufacturing tolerances required for prior art valves. Further, the piezoelectric actuator and other components of the valve are more easily assembled and more easily calibrated.

In one aspect of the invention, a flow control valve includes a support structure having a chamber in fluid communication with a first pressure port that extends through the support structure to a first opening, the first pressure port having a first longitudinal axis; a first pressure fitting received in the pressure port along the first longitudinal axis and having a first adjustable nozzle with a first end portion located within the chamber; a sealing member located within the chamber proximate the first end portion of the first adjustable nozzle; and a piezoelectric actuator located within the chamber and coupled to the sealing member, wherein actuation of the piezoelectric actuator moves a free face of the piezoelectric actuator and moves the sealing member in a direction substantially parallel to the first longitudinal axis of the first pressure port.

In another aspect of the invention, a method for regulating fluid flow to a chamber of a flow control valve includes supplying an amount of fluid to an adjustable nozzle coupled to a pressure fitting, the pressure fitting received in a bore formed in a support structure of the flow control valve, the pressure fitting oriented along a longitudinal axis of the bore, the adjustable nozzle having an orifice in fluid communication with the chamber and the pressure fitting; controllably changing a dimension of a piezoelectric actuator located within the chamber to selectively move a sealing member into and out of a sealed contact with the orifice of the adjustable nozzle; and releasing a portion of the fluid from the orifice of the adjustable nozzle into the chamber to regulate a flow rate of the fluid as the fluid exits the chamber.

### BRIEF DESCRIPTION OF THE DRAWINGS

Preferred and alternative embodiments of the present invention are described in detail below with reference to the following drawings:

FIG. 1 is top plan schematic view of a flow control valve having an piezoelectric actuator according to an embodiment of the invention; and

FIG. 2 is an expanded, top plan schematic view of a chamber and a piezoelectric actuator of the flow control valve of FIG. 1; and

FIG. 3 is a schematic diagram of a control system for controlling a voltage applied to a piezoelectric actuator of a flow control device.

### DETAILED DESCRIPTION OF ONE EMBODIMENT

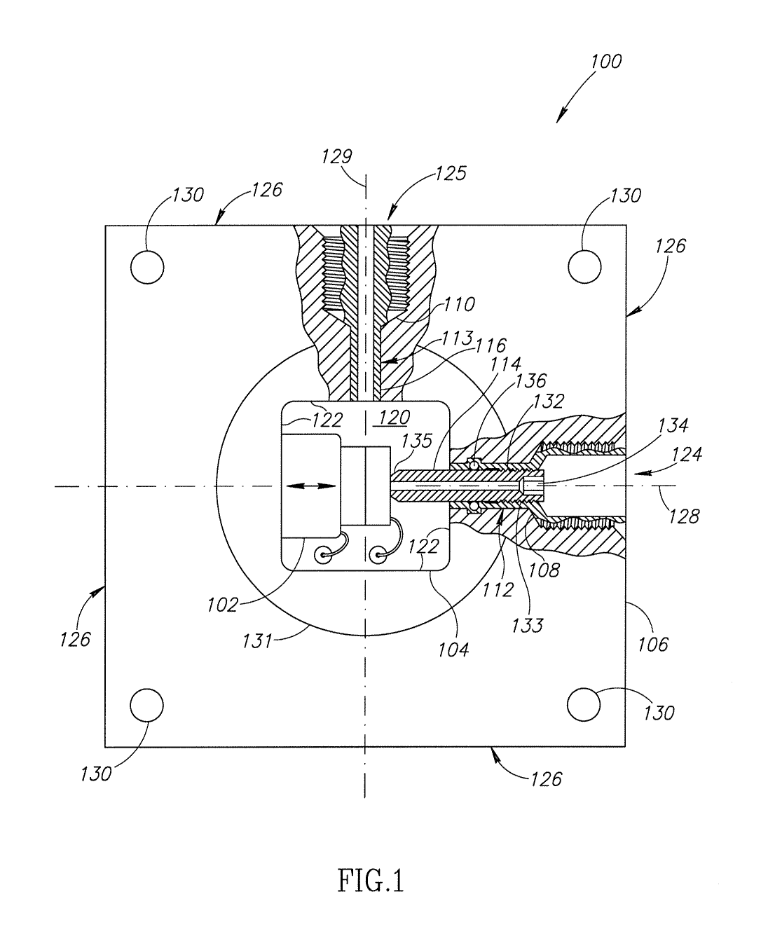

FIG. 1 shows a flow control valve 100 having a piezoelectric actuator 102 located within a chamber 104 of a valve support structure 106 according to an embodiment of the invention. The flow control valve 100 may be used to control a flow of fluid into the chamber 104. The flow control valve 100 may be employed to proportionally modulate the flow into the chamber 104 to achieve a desired output flow rate of the fluid.

The flow control valve 100 further includes a first pressure fitting 108 and a second pressure fitting 110 coupled to and positioned within passages 112, 113 formed in the support structure 106. In the illustrated embodiment, an adjustable nozzle 114 is coupled to the first pressure fitting 108 and a fixed nozzle 116 is coupled to the second pressure fitting 110.

In one embodiment, the support structure 106 is a machined, one-inch thick aluminum plate having approximately a two-inch square area (width×length). Machining material out of the support structure 106 forms the chamber 104. The chamber 104 may take a variety of shapes, but preferably does not extend through the thickness of the plate. In the event that the chamber 104 extends through the thickness of the support structure 106, a cover plate (not shown) may be used to close off an exterior side of the chamber 104. In the illustrated embodiment, the chamber 104 is relatively square having a floor surface 120 and four inner side walls 122.

The passages 112, 113 for the pressure fittings 108, 110 extend, respectively, from the inner side walls 122 of the chamber 104 through the support structure 106 to openings 124, 125 on exterior surfaces 126 of the support structure 106. In one embodiment, the passages 112, 113 have respective longitudinal axes 128, 129, which are arranged substantially perpendicular to each other. For example the passage 112 with longitudinal axis 128 is positioned at a three o'clock position while the passage 113 with longitudinal axis 129 is positioned at a twelve o'clock position. In addition to the aforementioned features, the support structure 106 may further include mounting holes 130 for securing a cover plate (not shown) to the support structure 106. Further, the cover plate may be sized to extend beyond a groove or boundary region 131 formed in the support structure 106. The groove 131 may receive an o-ring seal (not shown).

In one embodiment, both pressure fittings 108, 110 comply with military specification MS33649, but it is appreciated that other types of pressure fittings compatible with other specifications and compatible with the support structure 106 may be utilized. The pressure fittings 108, 110 are received in passages 112, 113 and along longitudinal axes 128, 129, respectively, and are coupled to the support structure 106. In the illustrated embodiment, the pressure fittings 108, 110 are threadably coupled to the support structure 106. The first pressure fitting 108 includes the adjustable nozzle 114 while the second pressure fitting 110 includes the fixed nozzle 116. At least a portion of each of the nozzles 114, 116 extends into the chamber 104.

The adjustable nozzle 114 includes an engagement portion 132 for coupling the adjustable nozzle 114 to the first pressure fitting 108. In one embodiment, the engagement portion 132 includes finely machined threads 133 that allow the adjustable nozzle 114 to be moved in small increments relative to the support structure 106. The engagement portion 132 is received by a complementary portion of the first pressure fitting 108. Adjustment of the adjustable nozzle 114 may be achieved with a tool engagement opening 134, which may take the form of a hex setscrew configured to receive a hex-shaped tool (not shown). In one embodiment, the adjustable nozzle 114 includes a nose cap 135. A seal 136, such as an o-ring seal, provides a fluid-tight fit between the adjustable nozzle 114 and the first pressure fitting 108.

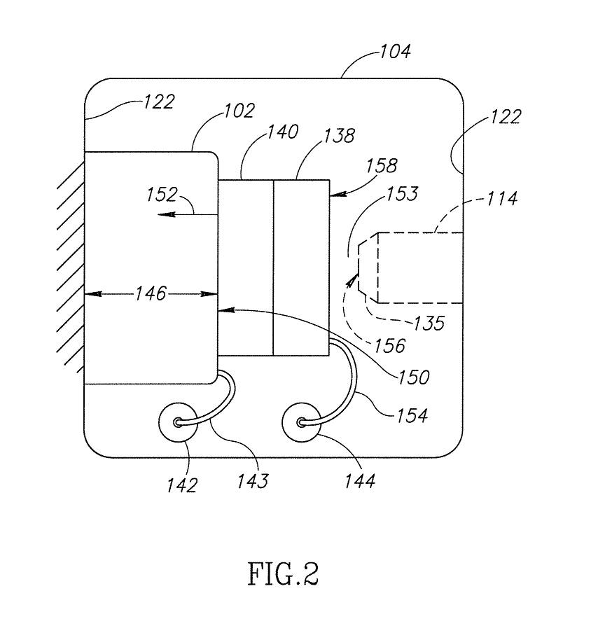

The piezoelectric actuator 102 is coupled to a sealing member 138 (FIG. 2), and both are located within the chamber 104. A unique aspect of the piezoelectric actuator 102 is its ability to change its dimensional shape by a small amount when subjected to an externally applied voltage of a desired polarity. Some of the more common piezoelectric materials are poly-crystalline ceramics based on lead zirconate titanate and barium titanate compositions. In some instances, additives may be added to the piezoelectric material to alter the dielectric, piezoelectric and/or physical properties of the resulting composition. In one embodiment, the piezoelectric actuator 102 is a piezo-ceramic actuator.

FIG. 2 is an expanded, top plan view of the chamber 104 containing only the piezoelectric actuator 102, the sealing member 138, an insulating spacer 140, and electrical excitation leads 142, 144. The pressure fittings 108, 110 are not shown in detail for purposes of clarity. The piezoelectric actuator 102 is fixed to the sidewall 122 of the chamber 104 opposite the sidewall 122 that receives the adjustable nozzle 114. One side of the piezoelectric actuator 102 is grounded to the support structure 106 while also being connected to the electrical excitation lead 142 through a wire 143. In one embodiment, alternate metallizations between ceramic donuts comprising the piezoelectric actuator 102 are connected to the support structure 106 and intervening metallizations are connected to the excitation lead 142. The support structure 106 may also operate as an electrical terminal. Polarities of the ceramic donuts are alternated such that the positive sides of all donuts are connected to the support structure 106 and the negative sides are connected to the excitation lead 142 or vice versa.

In addition, the piezoelectric actuator 102 is coupled to the sealing member 138 and yet electrically insulated from the sealing member 138 via the intermediate insulating spacer 140. In one embodiment, the intermediate insulating spacer 140 takes the form of a donut shaped ceramic insulator that is bonded or otherwise attached to the piezoelectric actuator 102 and to the sealing member 138.

The piezoelectric actuator 102 includes a first dimension 146 that is substantially parallel to the longitudinal axis 128 (FIG. 1) of the first passage 112. In operation, the first dimension 146 is reduced or shrunk when the piezoelectric actuator 102 is subjected to the externally applied voltage of the desired polarity via the electrical excitation source 142. The reduction of the first dimension 146 causes a free face 150 of the piezoelectric actuator 102, the intermediate insulating spacer 140 and the sealing member 138 to move away from the nose cap 136 of the adjustable nozzle 114 in a direction indicated by arrow 152. It is understood that other dimensions of the piezoelectric actuator 102 may be altered when subjected to the externally applied voltage, but for purposes of this description the changes in those other dimensions are not expected to effect the desired operation of the piezoelectric actuator 102 in controlling a gap 153 between the nose cap 135 of the adjustable nozzle 114.

In one embodiment, the sealing member 138 is a self-aligning valve-orifice sealing mechanism coupled to the insulating spacer 140. The self-aligning valve-orifice sealing mechanism may take the form of a spherical valve-orifice sealing device as described in U.S. Pat. No. 6,202,669 or make take other forms commonly employed for sealing a flow orifice. The sealing member 138 is electrically conductive and is attached to a wire 154 to form the electrical connection with the electrical excitation source 144. The conductive path may be advantageously used to measure distance (by capacitance) and contact (by resistance) between an end face 156 of the nose cap 136 of the adjustable nozzle 114 and an end face 158 of the sealing member 138.

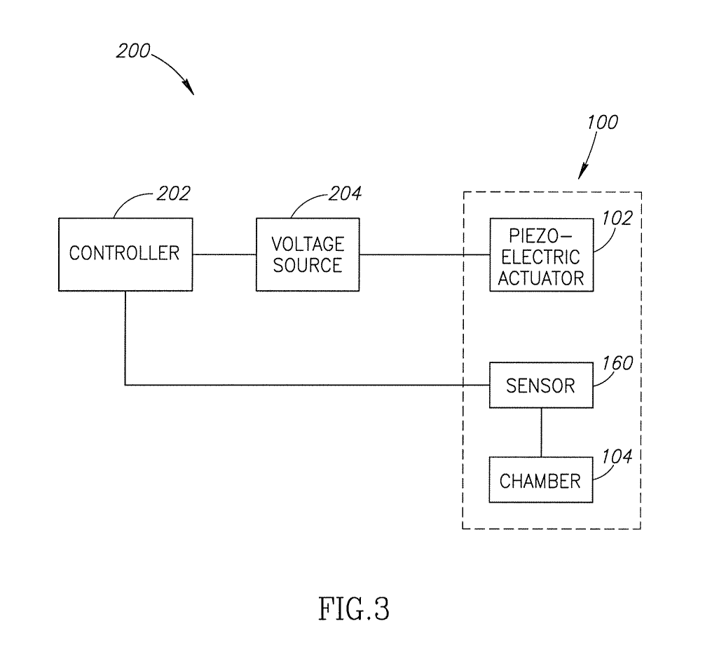

In operation, fluid flows through the adjustable nozzle 114 from the first pressure fitting 108. To receive the fluid into the chamber 104, the dimension 146 of the piezoelectric actuator 102 is changed or displaced by altering the magnitude and/or polarity of the voltage applied to the piezoelectric actuator. FIG. 3 shows a control system 200 includes a controller 202 for controlling a voltage source 204 that supplies the voltage magnitude and polarity necessary to drive the piezoelectric actuator 102 as described above. A sensor 160 is located in the chamber 104 to detect a flow or a pressure of the fluid within or about to exit the chamber 104. The sensor 160 transmits a signal to the controller 202, and based on the signal from the sensor 160, the controller 202 may alter the applied voltage level and/or polarity from the voltage source 204 to thus control or regulate an output flow from the flow control valve 100.

While one embodiment of the invention has been illustrated and described, as noted above, many changes can be made without departing from the spirit and scope of the invention. Accordingly, the scope of the invention is not limited by the disclosure of one embodiment. Instead, the invention should be determined entirely by reference to the claims that follow.

The embodiments of the invention in which an exclusive property or privilege is claimed are defined as follows:

1. A flow control valve comprising:
a support structure having a chamber in fluid communication with a first pressure port that extends through the support structure to a first opening, the first pressure port having a first longitudinal axis;
a first pressure fitting received in the pressure port along the first longitudinal axis and having a first adjustable nozzle with a first end portion located within the chamber;
a sealing member located within the chamber proximate the first end portion of the first adjustable nozzle; and
a piezoelectric actuator located within the chamber and coupled to the sealing member, wherein actuation of the piezoelectric actuator moves a free face of the piezoelectric actuator and moves the sealing member in a direction substantially parallel to the first longitudinal axis of the first pressure port.

2. The flow control valve of claim 1, further comprising an insulating spacer positioned between the sealing member and the piezoelectric actuator.

3. The flow control valve of claim 1, further comprising a controller to control a voltage source used to actuate the piezoelectric actuator.

4. The flow control valve of claim 3, wherein the voltage is supplied at a desired level and a desired polarity to achieve a dimensional change of the piezoelectric actuator in a direction substantially parallel to the first longitudinal axis.

5. The flow control valve of claim 1, wherein the first adjustable nozzle includes a plurality of external machine threads that engage internal machine threads formed in the first pressure fitting, wherein rotation of the first adjustable nozzle about the first longitudinal axis moves the adjustable nozzle either toward or away from the sealing member.

6. The flow control valve of claim 1, wherein the sealing member is self-aligning with respect to the adjustable nozzle.

7. The flow control valve of claim 1, wherein the piezoelectric actuator is a multi-layer piezo-ceramic actuator.

8. The flow control valve of claim 7, wherein the piezo-ceramic actuator is made from the group consisting of a poly-crystalline ceramic based lead zirconate titanate composition and a barium titanate composition.

9. The flow control valve of claim 1, wherein the piezoelectric actuator is fixed to a sidewall of the chamber.

10. The flow control valve of claim 1, further comprising:
a second pressure port that extends from the chamber through the support structure to a second opening, the second pressure port having a second longitudinal axis; and
a second pressure fitting received in the second pressure port along the second longitudinal axis, the second pressure fitting having a second nozzle with a second end located within the chamber of the support structure.

11. The flow control valve of claim 10, wherein the second longitudinal axis is substantially perpendicular to the first longitudinal axis.

12. A method for regulating fluid flow to a chamber of a flow control valve, the method comprising:
supplying an amount of fluid or gas to an adjustable nozzle coupled to a pressure fitting, the pressure fitting received in a bore formed in a support structure of the flow control valve, the pressure fitting oriented along a longitudinal axis of the bore, the adjustable nozzle having an orifice in fluid communication with the chamber and the pressure fitting;
controllably changing a dimension of a piezoelectric actuator located within the chamber to selectively move a sealing member into and out of a sealed contact with the orifice of the adjustable nozzle; and
releasing a portion of the fluid from the orifice of the adjustable nozzle into the chamber to regulate a flow rate of the fluid as the fluid exits the chamber.

13. The method of claim 12, further comprising detecting an amount of contact pressure between the pressure fitting and an end face of the sealing member.

14. The method of claim 12, further comprising detecting a distance between the pressure fitting and an end face of the sealing member.

15. The method of claim 12, wherein controllably changing the dimension of the piezoelectric actuator includes receiving a signal from a sensor located in the chamber and controlling a voltage source to provide a desired voltage level having a desired polarity and magnitude to the piezoelectric actuator to move a free face of the actuator and move the sealing member either toward or away from the orifice of the adjustable nozzle.

16. The method of claim 14, wherein applying the desired voltage level having the desired polarity includes applying the desired voltage level of either polarity.

17. The method of claim 12, wherein supplying the amount of fluid to the adjustable nozzle includes supplying pressurized air, nitrogen, or another gas.

18. The method of claim 12, wherein supplying the amount of fluid to the adjustable nozzle includes supplying pressurized nitrogen.

19. The method of claim 12, wherein controllably changing the dimension of the piezoelectric actuator includes repeatedly adjusting a voltage magnitude and polarity provided to the piezoelectric actuator in a closed loop arrangement.

20. The method of claim 12, wherein controllably changing the dimension of the piezoelectric actuator includes changing the dimension of the piezoelectric actuator that is substantially parallel to the longitudinal axis of the bore.

21. The method of claim 12, wherein releasing the portion of the fluid from the orifice of the adjustable nozzle includes moving the sealing member out of the sealed contact with the orifice of the adjustable nozzle.

22. The method of claim 12, wherein controllably changing the dimension of the piezoelectric actuator includes controllably changing the dimension of a multi-layer piezo-ceramic actuator.
